(19) United States
(12) Patent Application Publication
(10) Pub. No.: US 2018/0018478 A1
(43) Pub. Date: Jan. 18, 2018

(54) INDICATION APPENDING METHOD AND INDICATION APPENDED ARTICLE

(71) Applicant: LENOVO (SINGAPORE) PTE. LTD., Singapore (SG)

(72) Inventors: Takashi Sugawara, Yokohama-shi (JP); Tadashi Kosuga, Yokohama-shi (JP)

(73) Assignee: LENOVO (SINGAPORE) PTE. LTD., Singapore (SG)

(21) Appl. No.: 15/615,991

(22) Filed: Jun. 7, 2017

(30) Foreign Application Priority Data
Jul. 12, 2016 (JP) 2016137604

(51) Int. Cl. G06K 1/12; B23K 26/362; B65C 9/46; G06K 19/06

(52) U.S. Cl. CPC G06K 1/121; G06K 19/06159; B23K 26/362; B65C 9/46; G06K 19/06037

(57) ABSTRACT

The present invention provides an indication appending method and an indication appended article that improve identifiability with ease. The indication appending method comprises the step of applying a coating material having a color different from a surface of the article onto the surface in the form of a layer, and the step of partially removing the coating material by irradiation with laser light and thereby forming identification information, which is a letter/character, a symbol, and/or a figure. The coating material may be applied onto a predetermined region, and thereby an indication may be formed by a part from which the coating material is removed.

### FIELD OF THE INVENTION

The present invention relates to an indication appending method and an indication appended article.

### BACKGROUND OF THE INVENTION

There are cases where, in regard to individual articles (for example, products and so forth of manufactures), different identification numbers and identification marks (barcodes, two-dimensional codes and so forth) are appended to the respective articles in order to discriminate not only catalog numbers of the articles but also manufacturing process histories of the articles from one another. It becomes possible for a user to acquire detailed information on the article concerned by recognizing the identification number and the identification mark which are appended to the article.

In the following Patent Document 1, there is disclosed a technique that an article is equipped with a metal part and a plastic part so as to facilitate recycling of the article and so as to make it possible to indicate the barcode on an outer surface of the article by eliminating a printing process using ink, the barcode is displayed in a color developed state on a surface of the plastic part by irradiation with laser light and a mark is engraved on a surface of the metal part by irradiation with laser light.

[Patent Document 1] Japanese Patent Application Laid-Open No. 2001-291076

### SUMMARY OF THE INVENTION

In many cases, a component such as an integrated circuit (IC) and so forth is made of plastic and the surface thereof is dark-colored in black and so forth. In a case where the same numeral and symbol are assigned to a plurality of articles as the product number and so forth of the articles, it is general to print white numeral and symbol on the articles by silk printing. However, since in the silk printing, it is requested to perform baking and development processing on a meshed screen, in a case where the identification numbers and the identification marks which are different according to the articles are assigned to the articles, the silk printing is not appropriate.

It is conceivable to engrave the identification numbers and the identification marks which are different according to the articles on the articles by irradiating the plastic part of each article with laser light. However, even when the identification number and the identification mark are engraved on the plastic part which is colored in black and so forth, it is difficult for the user to visually check the engraved identification number and mark and it is also difficult to read out the engraved identification number and mark by a reader. In addition, although use of a plastic which develops a color by irradiation with laser light is described in Patent Document 1, it is requested to mold the plastic by mixing a special additive into the plastic at the manufacturing stage of articles. Therefore, it is feared that a unit price of the article may be increased and it is difficult to apply the technique concerned to an article which has been purchased.

The present invention has been made in view of such circumstances and aims to provide an indication appending method and an indication appended article making it possible to improve identifiability with ease.

In order to solve the above mentioned subject, the indication appending method and the indication appended article of the present invention adopt the following measures.

That is, an indication appending method according to a first aspect of the present invention has the step of applying a first coating material having a color which is different from that of a surface of an article onto the surface of the article in the form of a layer and the step of partially removing the first coating material by irradiation with laser light and thereby forming an indication which is a letter/character, a symbol and/or a figure

An indication appending method according to a second aspect of the present invention has the step of applying a first coating material onto a surface of an article in the form of a layer, the step of applying a second coating material having a color which is different from that of the first coating material onto a surface of the first coating material in the form of a layer and the step of partially removing the second coating material while leaving the first coating material unremoved by irradiation with laser light and thereby forming an indication which is a letter/character, a symbol or a figure.

In an indication appended article according to a third aspect of the present invention, an indication which is a letter/character, a symbol and/or a figure is formed with a first coating material which has been applied onto a surface of the article, has been partially removed by irradiation with laser light and has a color which is different from that of the surface of the article.

In an indication appended article according to a fourth aspect of the present invention, a first coating material is applied onto a surface of the article and an indication which is a letter/character, a symbol and/or a figure is formed with a second coating material which has been partially removed by irradiation with laser light and has a color which is different from that of the first coating material.

According to the present invention, it becomes possible to improve the identifiability with ease.

### BRIEF DESCRIPTION OF THE DRAWINGS

FIG. 1 is a longitudinal sectional diagram illustrating one example of a coating material before formation of identification information pertaining to one embodiment of the present invention.

FIG. 2 is a longitudinal sectional diagram illustrating one example of the identification information pertaining to one embodiment of the present invention.

FIG. 3 is a plan view illustrating one example of the coating material before formation of the identification information pertaining to one embodiment of the present invention.

FIG. 4 is a plan view illustrating one example of the identification information pertaining to one embodiment of the present invention.

FIG. 5 is a plan view illustrating one altered example of the identification information pertaining to one embodiment of the present invention.

FIG. 6 is a longitudinal sectional diagram illustrating one example of a plurality of layers of coating materials before formation of the identification information pertaining to one embodiment of the present invention.

FIG. 7 is a longitudinal sectional diagram illustrating one example of the identification information pertaining to one embodiment of the present invention.

### DETAILED DESCRIPTION OF THE INVENTION

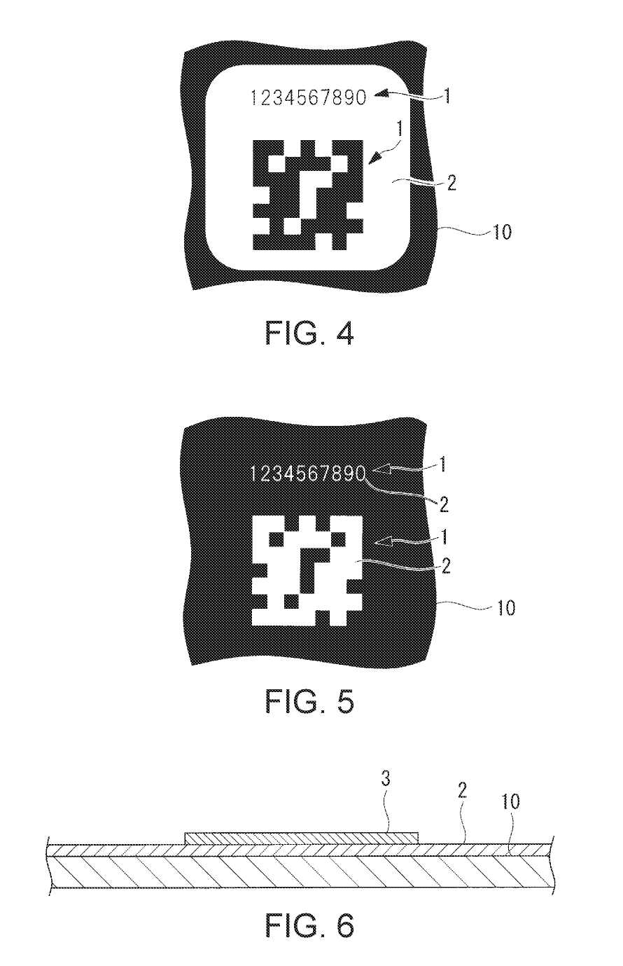

As illustrated in FIG. 2 and FIG. 4, identification information 1 pertaining to one embodiment of the present invention is appended to a surface of an article 10 such as, for example, a surface of a chassis of a laptop personal computer (a Laptop PC), a surface of a chassis of a tablet PC, a surface of a package of the integrated circuit (IC) and so forth. Incidentally, the article 10 to which the identification information 1 pertaining to the present embodiment is appended is not limited to these articles. [0021]The identification information 1 is, for example, an identification number and an identification mark (such as the barcode, the two-dimensional code and so forth) each of which is configured by at least any one of a letter/character, a symbol and a figure and is made different for every article 10. It becomes possible for a user to acquire detailed information on the article 10 concerned such as, for example, the catalog number, the manufacturing process history and so forth of the article 10 by recognizing the identification number and the identification mark appended to the article 10.

The identification information 1 is in the form of a cured and layered coating material 2 and is formed on the surface of the article 10. The color of the coating material 2 is different from that of the article 10. In a case where the article 10 is dark-colored in black and so forth, it is desirable that the identification information 1 be light-colored in white and so forth so as to make a contrast to the color of the article 10. In contrast, in a case where the article 10 is light-colored in white and so forth, it is preferable that the identification information 1 be dark-colored in black and so forth.

In the following, a method of appending the identification information 1 to the article 10 will be described.

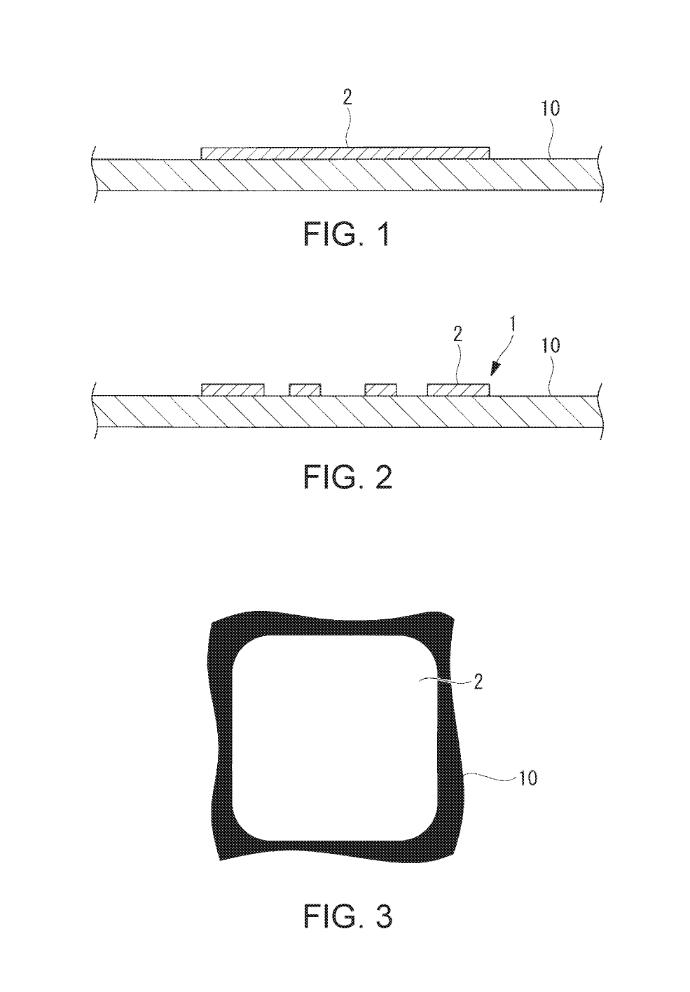

First, as illustrated in FIG. 1 and FIG. 3, the coating material 2 is applied onto the surface of the article 10 in the form of a layer. In the example illustrated in the drawings, the surface of the article 10 is black and the coating material 2 is white. Application of the coating material 2 onto the article 10 is performed by, for example, silk printing. The coating material 2 is, for example, an ultraviolet ray curable ink and so forth. The coating material 2 is applied onto a predetermined region, for example, in the form of an almost square shape as illustrated in FIG. 3.

After the applied coating material 2 has been cured, the coating material 2 is partially removed by irradiating the coating material 2 with laser light and the identification information 1 is formed within the predetermined region formed with the coating material 2 on the surface of the article 10 as illustrated in FIG. 2 and FIG. 4. That is, on a part from which the coating material 2 has been removed, the surface of the article 10 is exposed and the identification information 1 is formed by the part from which the coating material 2 has been removed. As a result, since the color that the article 10 has is different from the color that the coating material 2 has, it becomes easy for the user to visually check the identification information 1 and reading of the identification information 1 by the reader is facilitated with the aid of the contrast between the color that the article 10 has and the color that the coating material 2 has.

In addition, although in the above-mentioned example, a case of forming the identification information 1 within the predetermined region which has been formed with the coating material 2 has been described, the present invention is not limited to this case.

That is, as illustrated in FIG. 1 and FIG. 3, after the coating material 2 has been applied onto the surface of the article 10 in the form of a layer and the applied coating material 2 has been cured, the coating material 2 may be partially removed by irradiating the coating material 2 with laser light and thereby the identification information 1 may be formed as illustrated in FIG. 5. That is, after the coating material 2 has been partially removed, the identification information 1 is formed using a part on which the coating material 2 has remained unremoved.

Also in this case, since the color that the article 10 has is different from the color that the coating material 2 has, it becomes easy for the user to visually check the identification information 1 and reading of the identification information 1 by the reader is facilitated with the aid of the contrast between the color that the article 10 has and the color that the coating material 2 has.

Further, although in the above-mentioned example, a case of forming only one layer of the coating material 2 has been described, the present invention is not limited to this case. That is, the coating material to be applied onto the article 10 may have the plurality of layers such as, for example, two or more layers.

For example, as illustrated in FIG. 6, the coating material 2 is applied onto the surface of the article 10 in the form of a layer. Application of the coating material 2 onto the article 10 is performed by, for example, silk printing. The coating material 2 may be applied onto the entire surface of the article 10 as illustrated in FIG. 6 and/or may be applied onto the predetermined region.

After the applied coating material 2 has been cured, a coating material 3 is applied onto a surface of the coating material 2 in the form of a layer. For example, the coating material 2 is black and the coating material 3 is white. Application of the coating material 3 is performed by, for example, silk printing. The coating material 3 may be applied onto the predetermined region as illustrated in FIG. 6 and/or may be applied onto the entire surface of the coating material 2.

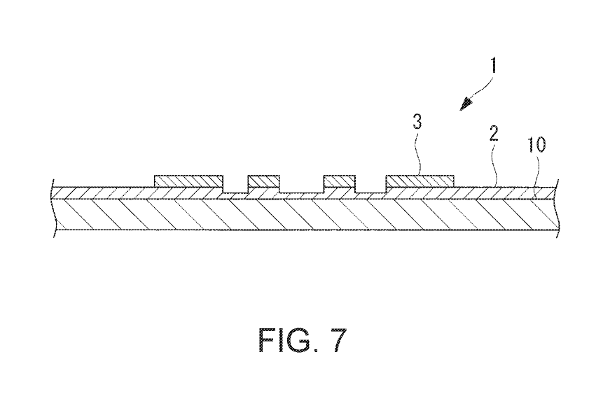

After the applied coating material 3 has been cured, the coating material 3 is partially removed by irradiating the coating material 3 with laser light while leaving the coating material 2 unremoved so as to form the identification information 1 within the predetermined region formed with the coating material 3 on the surface of the coating material 2 as illustrated in FIG. 7. The identification information 1 is appended, for example, in such a state as illustrated in FIG. 4 in the above-mentioned example (incidentally, the symbol 2 in FIG. 4 is replaced with the symbol 3 and the symbol 10 in FIG. 4 is replaced with the symbol 2). That is, on a part from which the coating material 3 has been removed, the surface of the coating material 2 is exposed and the identification information 1 is formed by the part from which the coating material 3 has been removed. As a result, since the color that the coating material 2 has is different from the color that the coating material 3 has, it becomes easy for the user to visually check the identification information 1 and reading of the identification information 1 by the reader is facilitated with the aid of the contrast between the color that the coating material 2 has and the color that the coating material 3 has.

Incidentally, also the case of forming two layers of the coating materials in this way is not limited to the case of forming the identification information 1 within the predetermined region which has been formed with the coating material 3. That is, the identification information 1 may be formed by a part on which the coating material 3 remains unremoved after the coating material 3 has been partially removed. In this case, the identification information 1 is appended, for example, in a state as illustrated in FIG. 5 in the above-mentioned example (incidentally, the symbol 2 in FIG. 5 is replaced with the symbol 3 and the symbol 10 in FIG. 5 is replaced with the symbol 2).

As described above, according to the present embodiment, the identification information 1 is formed by removing the coating materials 2 and 3 by irradiation with laser light and thereby it becomes easy for the user to visually check the identification information 1 and reading of the identification information 1 by the reader is facilitated with the aid of the contrast in color between the coating material 2 and the surface of the underlying article 10 or the contrast in color between the coating material 3 and the underlying coating material 2.

Since it is possible to form the identification information 1 by irradiation with laser light, it becomes possible to append with ease the identification information 1 which is made different for every article 10 in comparison with a case of appending the identification information by silk printing and so forth. In addition, since the identification information 1 is configured by the cured coating material, in a case where it is wished to remove the identification information 1 such as when the identification information 1 becomes useless, it is possible to completely remove the identification information 1 by irradiation with laser light and so forth.

Further, it is not requested to use the plastic which develops color by irradiation with laser light and the plastic may not be molded by mixing the special additive into the plastic at the manufacturing stage of the article 10 unlike Patent Document 1. Accordingly, even in a case where it is difficult to perform specific processing on a plastic molding, it is possible to append the identification information 1 which makes a contrast to others in color also onto, for example, the article 10 which has been purchased.

Incidentally, although in the above-mentioned embodiment, the example that the indication which is appended by the indication appending method pertaining to the present embodiment is the identification information 1 has been described, the present invention is not limited to this example. That is, the indication may be a landmark, a sign, an informative label in the form of a word, a sentence and so forth.

We claim:

1. An indication appending method comprising:
applying a first coating material, having a color which is different from that of a surface of an article, onto the surface of the article in the form of a layer; and
partially removing the first coating material by irradiation with laser light and thereby forming an indication which is a letter/character, a symbol and/or a figure.

2. The indication appending method according to claim 1, wherein:
the first coating material is applied onto a predetermined region, and
the indication is formed by a part from which the first coating material has been removed in the predetermined region.

3. The indication appending method according to claim 1, wherein:
after the first coating material has been partially removed, the indication is formed by a part on which the first coating material remains.

4. An indication appending method comprising:
applying a first coating material onto a surface of an article in the form of a layer;
applying a second coating material having a color which is different from that of the first coating material onto a surface of the first coating material in the form of a layer; and
partially removing the second coating material while leaving the first coating material unremoved by irradiation with laser light and thereby forming an indication which is a letter/character, a symbol and/or a figure.

5. The indication appending method according to claim 1, wherein:
the indication is identification information regarding information on the article.

6. An indication appended article comprising:
an indication, which is a letter/character, a symbol and/or a figure formed with a first coating material,
wherein the first coating material is applied onto a surface of the article, partially removed by irradiation with laser light, and has a color different from that of the surface of the article.

7. An indication appended article comprising:
a surface on which a first coating material is applied; and
an indication on the surface, which is a letter/character, a symbol and/or a figure,
wherein the indication is formed with a second coating material applied onto the first coating material, and partially removed by irradiation with laser light, and the second coating material has a color different from that of the first coating material.
